(19) United States
(12) Patent Application Publication
(10) Pub. No.: US 2007/0095056 A1
(43) Pub. Date: May 3, 2007

(54) Exhaust extractor manifold improvements

(75) Inventor: Michael Richter, South Australia (AU)

Correspondence Address: OSHA LIANG L.L.P., 1221 MCKINNEY STREET, SUITE 2800, HOUSTON, TX, 77010, US

(73) Assignee: Pacemaker Headers Pty Ltd, South Australia (AU)

(21) Appl. No.: 11/527,320

(22) Filed: Sep. 26, 2006

(30) Foreign Application Priority Data
Sep. 26, 2005 (AU) 2005905283

(51) Int. Cl. F02B 27/02; F01N 7/10

(52) U.S. Cl. 60/313; 60/323; 60/312

(57) ABSTRACT

The invention relates to an extractor manifold for an internal combustion engine including a pipe having a portion with a locally reduced internal diameter so as to thereby form a venturi, and a portion that is adapted to promote swirling of exhaust gas passing there through.

### FIELD OF THE INVENTION

The present invention relates to improvements to exhaust extractor manifolds.

### DESCRIPTION OF THE PRIOR ART

Excess exhaust backpressure is detrimental to vehicle engine performance. It is known that reducing restrictions to the flow of the combustion by-products (exhaust) from the combustion chamber of an internal combustion engine yields considerable improvements in the torque and power outputs, and the fuel, volumetric and thermal efficiencies of the engine.

The removal of the exhaust gases from the combustion chamber using the momentum of the exhaust gases in a long exhaust pipe, or by taking advantage of the pressure waves set up in the exhaust pipe by the discharge of the previously expelled gases, is known as scavenging. In addition to improving the exhausting of the combustion chamber, this scavenging effect also works in conjunction with the vacuum created by the piston during the inlet stroke, to assist in drawing in a fresh fuel charge.

Exhaust manifolds adapted to maximise scavenging effects are often known as ‘extractors’ or ‘headers’.

A well-designed extractor manifold comprises a plurality of bent steel pipes (one per cylinder), physically arranged so as to promote this scavenging effect. The pipes are also arranged in a fashion that consolidates them, so that there is only the one pipe channeling exhaust from that manifold to the rear of the car for release. These branches of pipes must therefore be consolidated at pipe connections or Junctions. For example, extractors for a six cylinder engine may incorporate three 2 into 1 junctions, and a further 3 into 1 junction further downstream.

It is an object of this invention therefore to provide an exhaust extractor manifold that provides improved scavenging, or at the least provides the public with a useful alternative to the exhaust manifolds of the prior art.

Other objects and advantages of the present invention will become apparent from the following description, taken in connection with the accompanying drawings, wherein, by way of illustration and example, an embodiment of the present invention is disclosed.

### SUMMARY OF THE INVENTION

In one form of this invention, there is proposed a venturi pipe for insertion in a pipe of an extractor manifold so that exhaust gas will pass there through, the venturi pipe including a portion having a locally reduced internal diameter and a portion that is adapted to promote the swirling of exhaust gas passing there through.

Preferably, the portion having a locally reduced internal diameter is at or toward an upstream end of the venturi pipe, and the portion adapted to promote swirling of exhaust gas passing there through is at or toward the downstream end of the venturi pipe.

In a further form, the invention may be said to lie in a portion of a pipe of an extractor manifold including a portion having a locally reduced internal diameter, and a portion that is adapted to promote swirling of exhaust gas passing there through.

Preferably, the portion adapted to promote swirling of exhaust gas passing there through is downstream of the portion having a locally reduced internal diameter.

In a further form, the invention may be said to lie in a connector portion for an extractor manifold having an upstream end adapted to accept at least two converging upstream supply pipes, where said connector pipe defines a substantially helical path in a downstream direction.

Preferably, the connector portion has an upstream end with an outer perimeter shape which substantially matches the outer perimeter shape of the converging supply pipes, there being a bulbous portion for each supply pipe, where each bulbous portion is progressively less outwardly protruding in a downstream direction, but also veering in a curved path which is for each and all of the bulbous portions in a same handed direction.

Preferably, the respective bulbous portions define together a helical path in a downstream direction of the single pipe.

In a further form, the invention may be said to lie in an exhaust extractor manifold assembly including at least two upstream pipes converging at a pipe having a connector portion, the connector portion having an upstream end that is adapted so as to accept the upstream pipes and define a substantially helical path in a downstream direction, the assembly further including a venturi pipe having a portion of locally reduced internal diameter and a portion that is adapted to promote swirling of exhaust gas passing there through, wherein the venturi pipe is inserted in a pipe of the assembly in a position located downstream of the connector portion, so that the connector portion and the venturi pipe are adapted to co-operatively define a substantially helical path for exhaust gasses in a downstream direction of the connector portion.

Preferably, the helical path defined by the venturi pipe and the bulbous portions are adapted to generate a vortex in exhaust gases passing through the assembly, which will augment the scavenging affect provided by the extractor manifold.

In a further form, the invention may be said to lie in an exhaust extractor manifold including at least two upstream pipes converging at a connector portion, the connector portion having an upstream end that is adapted so as to accept the upstream pipes and define a substantially helical path in a downstream direction, the assembly further including portion of pipe having a portion of locally reduced internal diameter and a portion that is adapted to promote swirling of exhaust gas passing there through, wherein said portion of pipe is in a position located downstream of the collector pipe so that the connector portion and said portion are adapted to co-operatively define a substantially helical path for exhaust gasses in a downstream direction of the connector portion.

In a further form, the invention may be said to lie in an installation in which there is an internal combustion engine, with an extractor assembly having one or more of the above-mentioned features.

### BRIEF DESCRIPTION OF THE DRAWINGS

For a better understanding of this invention it will now be described with respect to the preferred embodiment which shall be described herein with the assistance of drawings wherein;

FIG. 1 is a perspective view of the connector portion of an exhaust extractor manifold;

FIGS. 2 and 3 are perspective views of the venturi pipe from the exhaust extractor manifold in FIG. 1;

FIG. 4 is a cross-sectional view through the venturi pipe in FIGS. 2 and 3;

FIG. 5 is a perspective view of the connector portion of an exhaust extractor manifold according to a further embodiment of the invention.

### DETAILED DESCRIPTION OF THE INVENTION

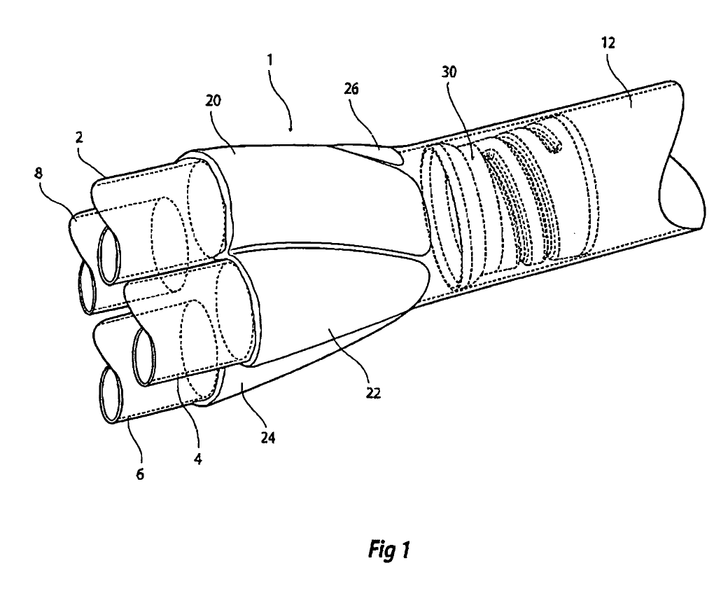

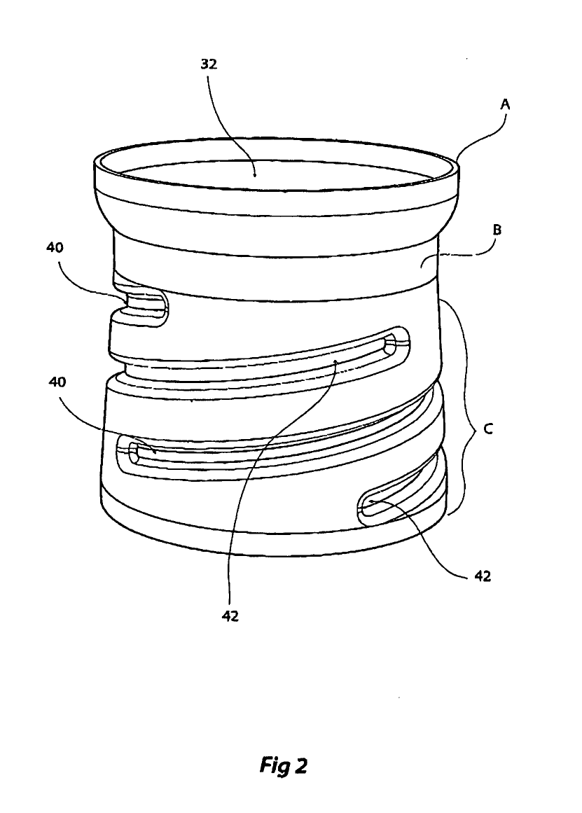

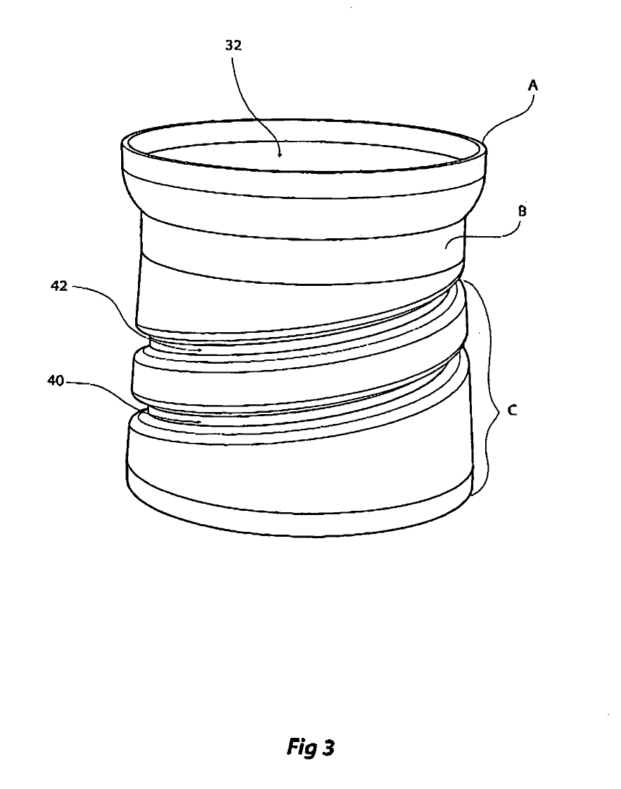

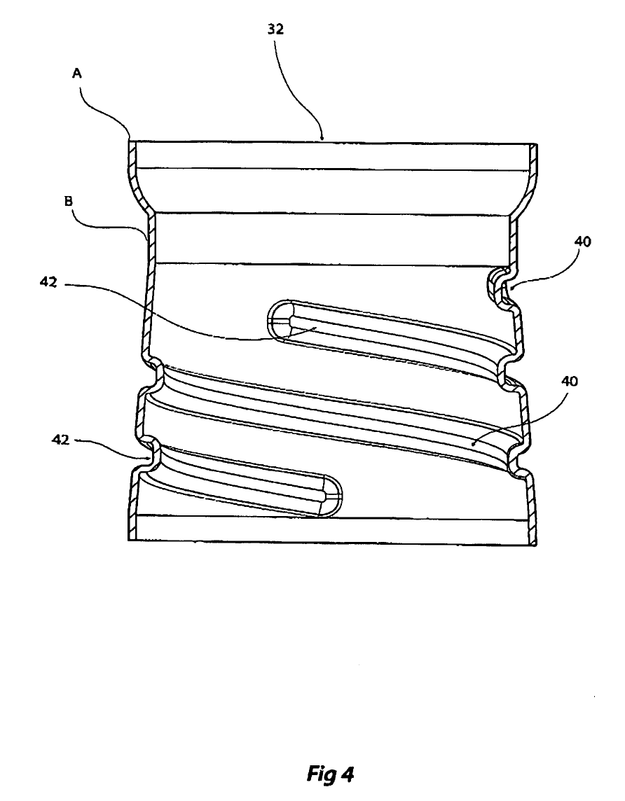

Now referring to the illustrations, and in particular to FIG. 1, where there is illustrated the connector portion 1 of an exhaust extractor manifold, which is made from tubular steel.

This connector portion 1 connects the upstream supply pipes 2, 4, 6, and 8, to a single pipe 12. An exhaust manifold assembly of this type would typically be adapted for use on a four cylinder engine, or a bank of 4 cylinders on a V8 engine, where each of the upstream pipes 2, 4, 6, and 8 is receiving combustion by-products from a combustion chamber of a cylinder, and the four pipes are converged into one pipe 12 via the connector portion 1, for the transfer of combustion by-products to the rear of the vehicle, where they are released to atmosphere.

Each of the upstream pipes 2, 4, 6 and 8 has a downstream end, each of a substantially circular shape, which are arranged in a converging and mutually adjoining alignment. The connector 1 has an upstream end with an outer perimeter shape that will accept within in it the outer perimeter shape of the mutually adjoining supply pipe ends. The result is an upstream defined by 4 bulbous forms 20, 22, 24 and 26. Each bulbous form is progressively less outwardly protruding at it extends in the downstream direction, and each also veers in an identical curved path in the downstream direction.

Positioned in the single pipe 12 at a position just downstream of the connector 10 is a steel venturi pipe 30, which provides an exhaust gas passageway 32 for the exhaust gasses to pass there through. All of the exhaust gas leaving the connector 1 passes through this venturi pipe 30.

The passageway 32 through the venturi pipe 30 has an inlet at A; just downstream of inlet A the pipe 30 tapers down, thereby reducing the internal diameter of the pipe at B. The exhaust gasses speed up as they pass through the restriction created by this reduced diameter, reducing their pressure and creating a partial vacuum, all of which are a result of the Bernoulli affect. After the restriction at B, the venturi pipe gradually opens out again along the remainder of the pipes length at C.

A pair of swirled grooves 40 and 42 are formed into the wall of the venturi pipe 30 so that they project inwardly of the wall of the pipe in the region C where the venturi pipe gradually opens out again. As exhaust gasses pass through the venturi pipe downstream of the constriction at B, they are swirled into a vortex by these swirled grooves 40 and 42.

In use then, the combined effect of the helical path defined by the shape of the connector 10 and the swirled grooves 40 and 42 in the venturi pipe 30, is intended to generate a vortex (clockwise in this case), which will create a suction that augments the scavenging affect provided by providing the correct arrangement of supply pipes 2, 4, 6, and 8 entering the connector; that arrangement being one which cooperates with the firing order of the engine to maximise the scavenging effect provided by the exhaust gas pulses.

It would be understood by a person skilled in the art that it is possible to use either of the shaped collector 10 or the venturi pipe 30 independently in an extractor manifold to obtain a performance gain. The best results however are obtained when these are used in combination as described.

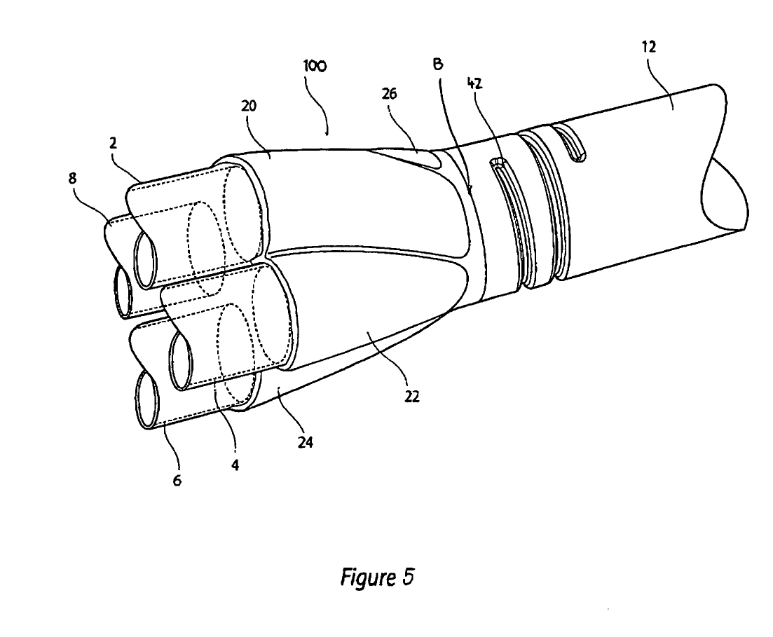

Referring now to FIG. 5, where there is illustrated an exhaust manifold assembly 100 wherein the venturi B and swirled portions 42 are formed in the outer pipe 12.

It is considered therefore that an exhaust extractor assembly such as that described herein would prove to be of considerable benefit to those seeking an exhaust extractor manifold that will improve the torque and power outputs, and the fuel, volumetric and thermal efficiency of their car engine.

Although the invention has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

1. An extractor manifold including a pipe having a portion with a locally reduced internal diameter so as to thereby form a venturi, and a portion that is adapted to promote swirling of exhaust gas passing there through.

2. The extractor manifold of claim 1, further characterised in that the venturi is at or toward an upstream end of the pipe, and the portion adapted to promote swirling of exhaust gas passing there through is at or toward the downstream end of the pipe.

3. The extractor manifold of claim 1, further characterised in that the portion adapted to promote swirling of exhaust gas passing there through has at least one swirled groove formed into it.

4. The extractor manifold as claim 2, further characterised in that the portion adapted to promote swirling commences at or near the venturi and progressively opens up in a downstream direction until the pipe once again has substantially the same diameter downstream of the venturi as it did upstream of it.

5. The extractor manifold as claim 1, further characterised in that the pipe is adapted to be inserted into a further pipe of the extractor manifold so that at least a substantive portion of the exhaust gas directed though the further pipe will pass there through.

6. The extractor manifold as in claim 1, further characterised in that the manifold includes a connector portion positioned upstream of the pipe, which is adapted to accept at least two converging upstream supply pipes, and where said connector defines a substantially helical path in a downstream direction.

7. The extractor manifold as in claim 6, further characterised in that the connector portion has an upstream end with an outer perimeter shape which substantially matches the outer perimeter shape of the converging supply pipes, there being a bulbous portion for each supply pipe, where each bulbous portion is progressively less outwardly protruding in a downstream direction, but also veering in a curved path which is for each and all of the bulbous portions in a same handed direction.

8. The extractor manifold as in claim 7, further characterised in that the respective bulbous portions define together a helical path in a downstream direction of the single pipe.

9. The extractor manifold as in claim 8, further characterised in that the helical path defined by the bulbous portions directs exhaust gases in the is same direction as the portion of the pipe adapted to promote swirling of exhaust gas passing there through.

10. The extractor manifold as in claim 9, further characterised in that the helical path defined by the pipe and the bulbous portions of the connector portion are adapted to generate a vortex in exhaust gases passing through the assembly, which will augment the scavenging affect provided by the extractor manifold.

11. An exhaust extractor manifold including at least two upstream pipes converging at a connector portion, the connector portion having an upstream end that is adapted so as to accept the upstream pipes and define a substantially helical path in a downstream direction, the assembly further including a pipe having a portion of locally reduced internal diameter and a portion that is adapted to promote swirling of exhaust gas passing there through, wherein the pipe is inserted in a further pipe of the assembly in a position located downstream of the connector portion, so that the connector portion and the pipe are adapted to co-operatively define a substantially helical path for exhaust gasses in a downstream direction of the connector portion.

12. An exhaust extractor manifold including at least two upstream pipes converging at a connector portion, the connector portion having an upstream end that is adapted so as to accept the upstream pipes and define a substantially helical path in a downstream direction, the assembly further including a portion of pipe having a portion of locally reduced internal diameter and a portion that is adapted to promote swirling of exhaust gas passing there through, wherein said portion of pipe is in a position located downstream of the collector pipe so that the connector portion and said portion are adapted to cooperatively define a substantially helical path for exhaust gasses in a downstream direction of the connector portion.

13. An installation in which there is an internal combustion engine, with an extractor having one or more of the above-mentioned features.
